(19) United States
(12) Patent Application Publication
(10) Pub. No.: US 2018/0109013 A1
(43) Pub. Date: Apr. 19, 2018

(54) Joint Position Determination Assisting Method

(71) Applicant: Yazaki Corporation, Tokyo (JP)

(72) Inventors: Shingo Hasegawa, Toyota-shi (JP); Kota Oishi, Toyota-shi (JP); Yu Ichikawa, Makinohara-shi (JP)

(73) Assignee: Yazaki Corporation, Tokyo (JP)

(21) Appl. No.: 15/786,085

(22) Filed: Oct. 17, 2017

(30) Foreign Application Priority Data
Oct. 18, 2016 (JP) 2016-204560

(51) Int. Cl. H01R 4/24; H01R 11/12; H02K 11/40

(52) U.S. Cl. CPC H01R 4/245; H01R 11/12; H01R 4/64; H01R 4/2429; H02K 11/40

(57) ABSTRACT

In a vehicle circuitry including an assembly of a plurality of wires and at least one joint point interconnecting the plurality of wires, a joint position determination assisting method assists an optimization of a position of the joint point. The method includes displaying visible information representing a wiring route and a configuration of the vehicle circuitry on a display screen based on basic design data representing the configuration of the vehicle circuitry, and in response to a designation of the joint point and an instruction for the optimization, calculating a length of each wire and a total wire length with the joint point being disposed at a plurality of mutually different positions, and outputting information representing an optimal position of the joint point, reflecting a result of comparison of the calculated total wire length at the respective positions.

### CROSS-REFERENCE TO RELATED APPLICATION

The present application claims priority from Japanese Patent Application No. 2016-204560 filed on Oct. 18, 2016, the entire content of which is incorporated herein by reference.

### FIELD OF INVENTION

The present invention relates to a method for assisting a determination of a joint position, and relates to a technology applicable in assisting a design of a circuitry in a vehicle such as a wire harness.

### RELATED ART

In a vehicle, electric power is supplied from a power source, e.g., a main battery or an alternator (generator), individually to numerous electrical components disposed at various locations on the vehicle. A plurality of electronic control units (ECUs) are interconnected so that they can mutually communicate. Signals output from various switches and sensors are transmitted to the electronic control units. Various loads are individually controlled, such as turned on and off, by signals output from the electronic control units.

To realize the connection between the power source and the respective electrical components and also the interconnection between the electrical components, wire harnesses, an assembly of numerous wires, have generally been used in the vehicles. A wire harness may be a bundle of numerous wires for forming circuits including power lines, ground lines, communication lines, etc. The wire harness may have a very complicated shape to connect one terminal of each electrical component to one or more terminals of another electrical component via a predetermined wiring route on the vehicle. Generally, a terminal is connected to an end of each wire of the wire harness, and this terminal is mounted in a corresponding cavity of a connector housing.

The circuit on the wire harness may include a point at which, for example, two, three or more wires are connected to a single wire. For example, numerous grounding wires may be connected to a common grounding terminal and numerous power wires may be connected to a common power source terminal.

Hence, such a joint connector as disclosed in JP 2003-77601A is used. With this connector, a plurality of wires can be connected to a common power source circuit or a common ground circuit via bus bars provided inside the connector. As disclosed in JP 2008-276969A, a plurality of wires may be connected to another wire by using a bonder provided at an intermediate section of the wire harness. Three wires may be interconnected by using a joint device disclosed in JP 2009-110761A. Using a joint terminal disclosed in JP2016-81625A, a wire can be connected to an intermediate portion of another wire.

Wire harnesses are desired to realize reduction in the total weight, manufacturing cost and component cost. However, to satisfy the need for allowable current, it is difficult to reduce the thickness of each wire (the cross-sectional area of a conductor) or to reduce the total number of wires.

On the other hand, a joint point on the wire harness at which a plurality of wires is connected, i.e., a position at which a joint connector, a bonder, a joint terminal or the like is disposed, may be changed as necessary. By changing the position of the joint point, the length of each wire to be connected to a component, such as a joint connector, is changed, whereby the wire length and weight of the entire wire harness are also changed. Hence, the configuration of the wire harness can be optimized and the total weight and the cost thereof can be reduced by changing the position of the joint point.

However, for example, when changing the position at which a single connector to which several tens of wires t different in wiring route and length are connected, it is difficult to understand whether the total length of the wires is going to be longer or shorter by the change unless he is a person of exceptional skill.

Further, the thickness values of the respective wires of the wire harness are not constant and are changed depending on the purpose of use. Hence, even when it is found that the total length of the wires is going to be shorter by changing the position of the connector, the total weight of the wire harness may increase instead of decrease in some cases. Moreover, even when it is found that the total length of the wires is going to be shorter by changing the position of the connector, the manufacturing cost and the component cost may increase in some cases.

Still further, an area such as a lower region in an engine room of a vehicle is exposed to water splashing from a road surface or the like, so a joint point (an exposed conductive portion) cannot be disposed in such an area unless costly waterproofing measures are specially taken.

### SUMMARY

Illustrative aspects of the present invention provide a joint position determination assisting method that is useful, when manufacturing a vehicle circuitry such as a wire harness, in optimizing a joint position in view of total weight and cost of the circuitry.

According to an illustrative aspect of the invention, a joint position determination assisting method is provided. In a vehicle circuitry including an assembly of a plurality of wires and at least one joint point interconnecting the plurality of wires, the method assists an optimization of a position of the joint point. The method includes displaying visible information representing a wiring route and a configuration of the vehicle circuitry on a display screen based on basic design data representing the configuration of the vehicle circuitry, and in response to a designation of the joint point and an instruction for the optimization, calculating a length of each wire and a total wire length with the joint point being disposed at a plurality of mutually different positions, and outputting information representing an optimal position of the joint point, reflecting a result of comparison of the calculated total wire length at the respective positions.

Other aspects and advantages of the invention will be apparent from the following description, the drawings and the claims.

### BRIEF DESCRIPTION OF THE DRAWINGS

FIG. 1 is a diagram illustrating an example of a configuration an assisting system for implementing a joint position determination assisting method according to one or more exemplary embodiment of the present invention;

FIG. 2 is a front view of an example of a display screen of a computer on which a plurality of display frames are displayed at respective sections on the display screen;

FIG. 3 is a front view of an example of a content displayed in a diagram-a display frame;

FIG. 4 is a front view of an example of a content displayed in an optimal joint position list display frame;

FIG. 5 is an electric circuit diagram of an example of a connection of circuits in a joint connector;

FIG. 6 is a flow chart of an example of a process for examining a joint position;

FIG. 7 is a flow chart of another example of a process for examining the joint position;

FIG. 8 is a schematic diagram illustrating a list of attributes contained in MT data;

FIG. 9 is a schematic diagram illustrating an example of a configuration of node attribute information contained in the MT data;

FIG. 10 is a schematic diagram illustrating an example of a configuration of segment attribute information contained in the MT data; and

FIG. 11 is a schematic diagram illustrating an example of a configuration of wire attribute information contained in the MT data.

### DETAILED DESCRIPTION

Hereinafter, exemplary embodiments of the present invention will be described with reference to the drawings.

Exemplary Environment for Application of Joint Position Determination Assisting Method

For example, when a wire harness to be mounted on a vehicle to be manufactured by a vehicle manufacturer (Company A) is manufactured by a component manufacturer (Company B), the design drawing data (first design drawing data) representing the wire harness required by Company A is usually provided from Company A to Company B. This design drawing data is created as data that can be used on the specific CAD (Computer Aided Design) system introduced in Company A.

Company B manufactures a wire harness based on the design drawing data received from Company A. Furthermore, Company B makes sure that the manufactured wire harness satisfies the specifications requested by Company A by carrying out inspection including actual dimensional measurements and then supplies the wire harness having passed the inspection to Company A. Company A mounts the wire harness supplied from Company B on a specific vehicle body and manufactures a vehicle.

In such an environment, Company B manufactures the wire harness so as conform to the design drawing data received from Company A. However, Company B carries out various investigations to optimize the wire harness to be manufactured. Furthermore, for example, in order to reduce the weight or cost of the wire harness, Company B makes a proposal to Company A to carry out design change for the contents of the design drawing data received from Company A in some cases.

More specifically, in order to reduce the weight of the entire wire harness and to reduce the component cost and the manufacturing cost of the wire harness, Company B carries out assessment, for example, as to whether the total length of the numerous wires (the sum of the lengths of the respective wires) forming the wire harness can be reduced.

For example, in the case that the position of a joint point at which the ends of a plurality of wires are connected to a single common wire is changed, the lengths of the respective wires passing through this joint point are changed, whereby the total wire length is also changed. In other words, the total wire length can be reduced by changing the position of the joint point on the wire harness. Further, the total weight of the wires forming the wire harness can be reduced and the component cost and the manufacturing cost can also be lowered by reducing the total wire length.

However, since an actual wire harness is composed of numerous wires having mutually different thickness values, even if the total length of the wires is reduced, it is possible that the total weight of the wires may increase or the component cost may increase instead of decreasing in some cases. Furthermore, at a joint point on a wire harness, the core of a wire or a portion of a metal terminal is in a state of being apt to be exposed to the outside or invaded by moisture, thereby being easily degradable. Hence, a joint point must be avoided from being disposed in a liquid intrusion area, such as the lower section in an engine room. If a joint point is disposed in such a liquid intrusion area, special waterproofing measures are required, whereby increase in cost is inevitable.

Moreover, in actual wire harnesses, for example, the interior of a joint connector in which several tens of wires are assembled is used as a joint point in many cases, or plural systems of joint points are present inside a single joint connector in many cases. Hence, it is very difficult for even a skilled designer or user to accurately grasp how the total wire length of the entire wire harness is changed by the change of the joint point.

The joint position determination assisting method according to one or more exemplary embodiments of the present invention is intended to facilitate the work of the designer or user who optimizes the positions at which respective joint points on a wire harness are disposed. In reality, the method can be realized as an assisting system using a computer as described later.

However, even in the case that the position at which a joint point is disposed is changed, it is necessary to grasp the lengths, etc. of the respective wires at all times. Hence, it is necessary to dispose the joint point at any one of node positions corresponding to the measuring points provided at various places on a wire harness.

The measuring points are reference points that are used when dimensions are measured on an actual wire harness. For example, it is necessary to manufacture a wire harness so that the actual dimension between one measuring point and another measuring point satisfies the conditions for the reference dimension and allowable tolerance specified in the design drawing data, to measure the actual dimension of the manufactured wire harness at an inspection process and then to confirm that the dimension actually satisfies the conditions.

However, the circumstances in manufacturing and the circumstances in inspection at Company B, for example, are not reflected to the design drawing data that is received by Company B from Company A. Hence, based on the received design drawing data (first design drawing data), Company B creates design drawing data (second design drawing data) that is made easily usable in consideration of the circumstances of Company B. More specifically, in the case that Company B does not adopt the same type of CAD system as that of Company A, Company B creates design drawing data in a versatile format, such as a text format, from the data format exclusively used for the corresponding CAD system, and carries out the manufacturing and inspection of a wire harness by using the created second design drawing data.

Configuration Example of Assisting System

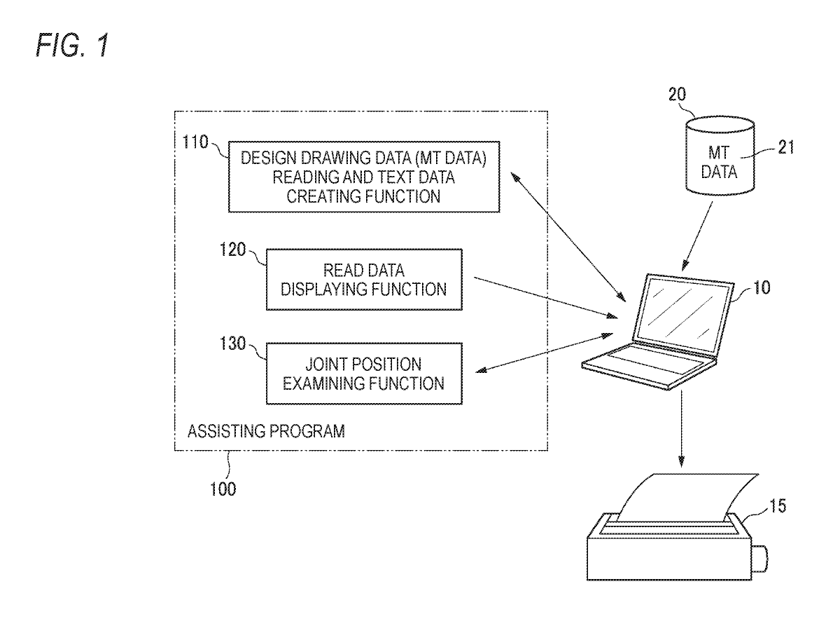

FIG. 1 illustrates an example of a configuration of an assisting system for implementing the joint position determination assisting method according to one or more exemplary embodiments of the present invention. The system of FIG. 1 includes a computer 10 and an assisting program 100 capable of being executed on the computer 10.

Furthermore, since the system is also provided with a printer 15, drawings and the like can be printed on paper as necessary.

The computer 10 may be a general computer, such as a notebook PC, and is assumed to be loaded with general-purpose basic software (operating system).

The design drawing data required to manufacture a target wire harness is provided from Company A to Company B as MT data 21 stored on an appropriate recording medium 20. At Company B, the computer 10 reads the MT data 21 stored on the recording medium 20 and uses the data.

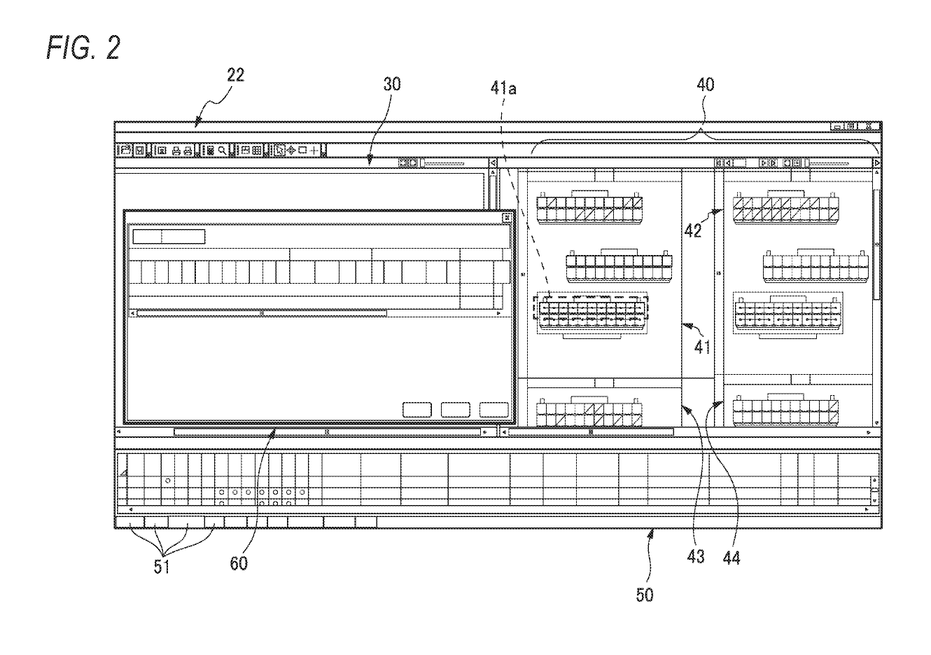

Design drawing data being easy to use at Company B can be created based on the MT data 21 by executing the assisting program 100 on the computer 10. The assisting program 100 shown in FIG. 2 includes a text data creating function 110, a read data displaying function 120 and a joint position examining function 130.

The text data creating function 110 is a program operating on the computer 10 to read the MT data 21 that can be used on a specific CAD system and to create text format data having high versatility.

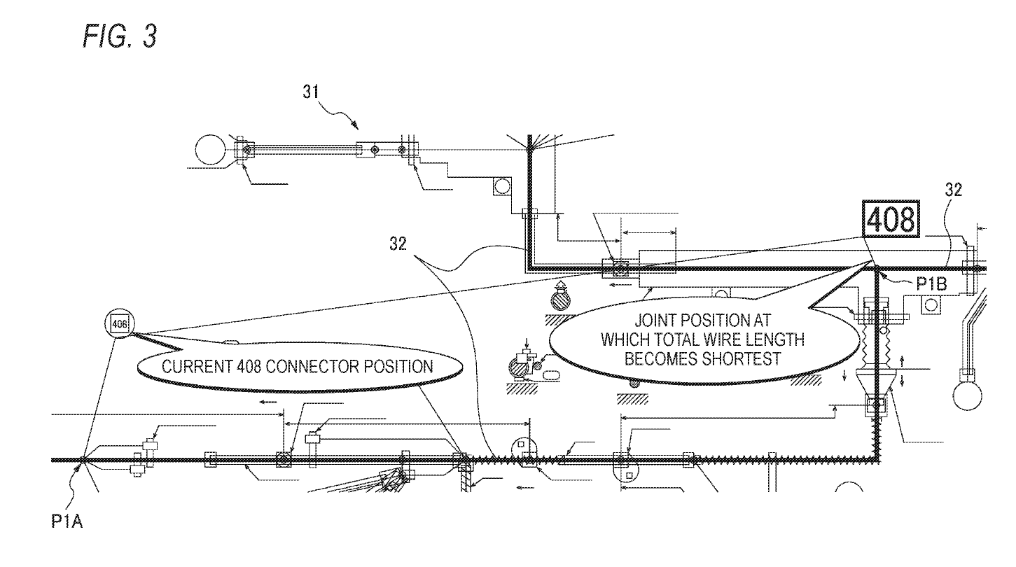

The read data displaying function 120 is a program for displaying, on the display screen of the computer 10, various kinds of information representing the wire harness to be manufactured based on the text data created by the text data creating function 110. The function can display such visible information as shown in FIGS. 2 and 3 on the display screen.

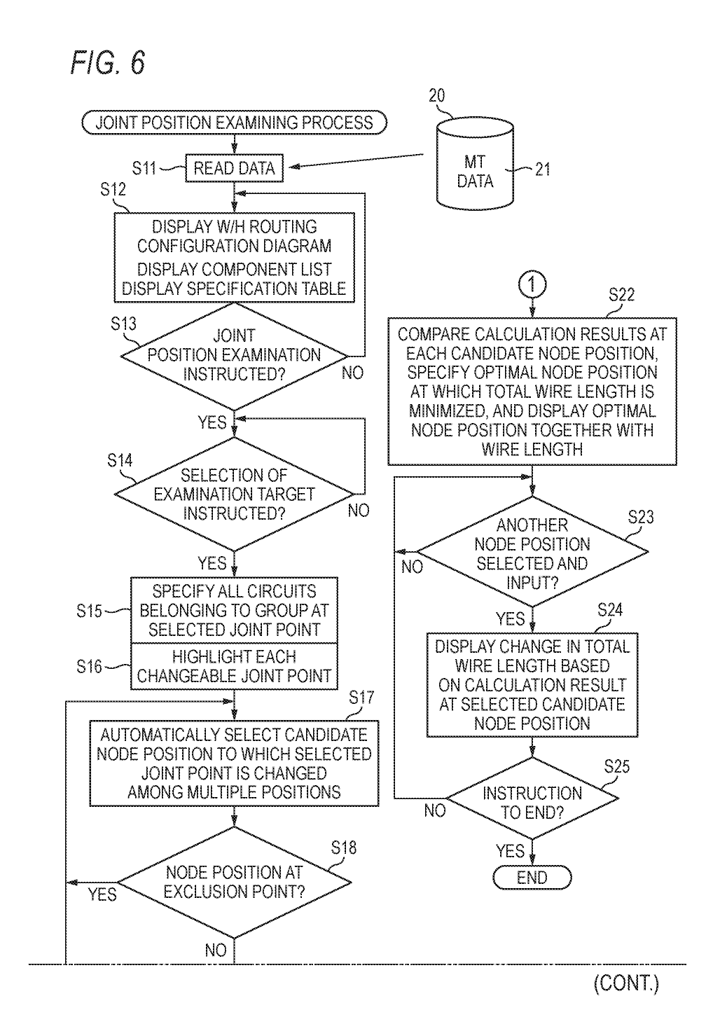

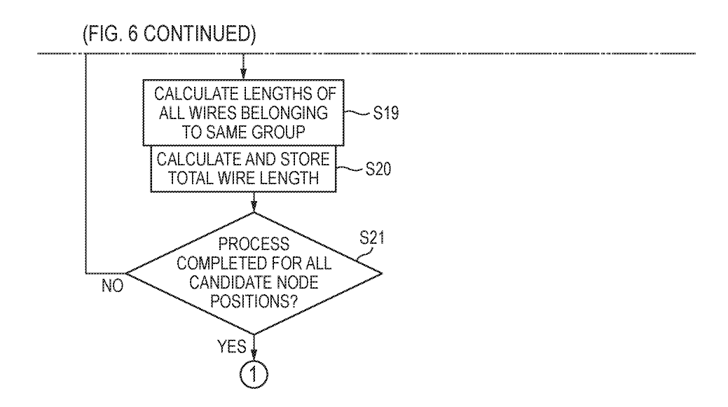

The joint position examining function 130 is a program for assisting the work for changing the positions of the joint points being present on the wire harness to optimize the positions. FIG. 6 shows the detailed procedure of the work. The procedure shown in FIG. 6 will be described later.

Example of Display Screen

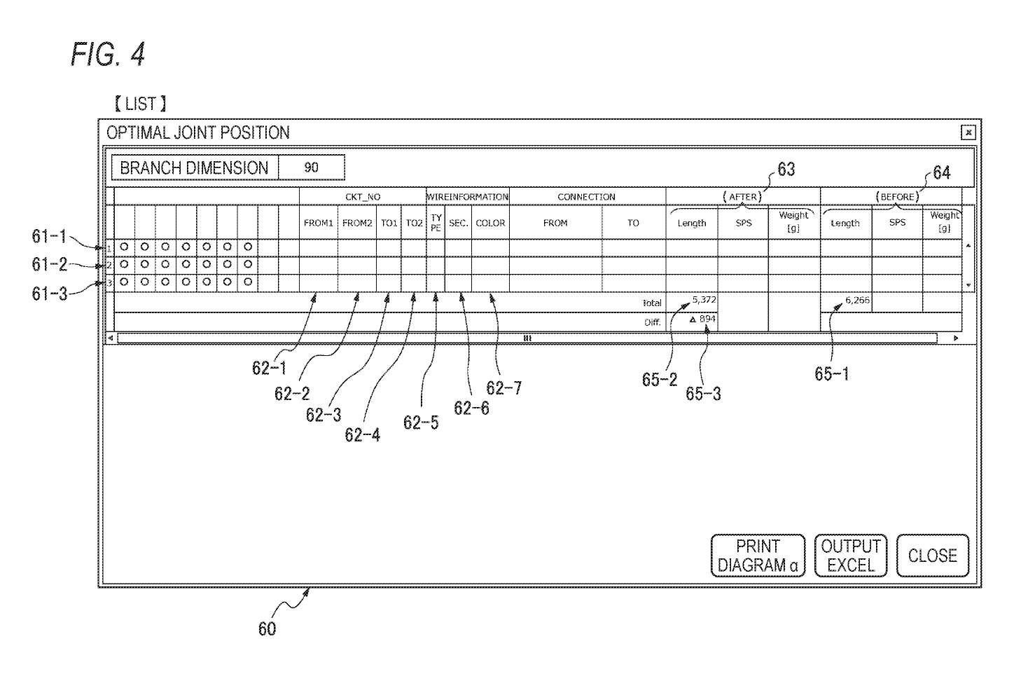

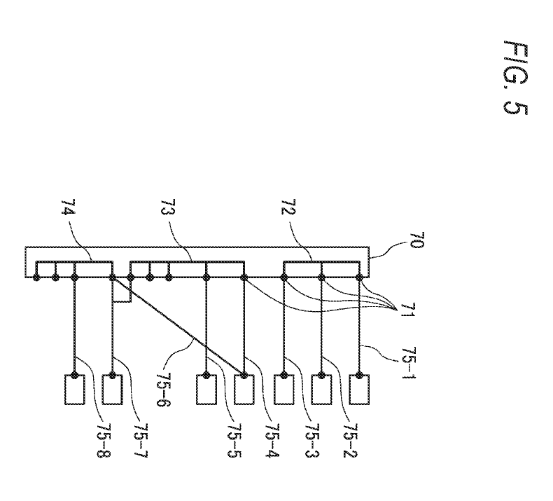

FIG. 2 illustrates an example of a display screen of the computer 10 on which a plurality of display frames are displayed at respective sections on the display screen. On the display screen of FIG. 2, a diagram-α display frame 30, a diagram-β display frame 40, a diagram-γ display frame 50 and an optimal joint position list display frame 60 are displayed. FIG. 3 illustrates an example of a content displayed in the diagram-α display frame 30. FIG. 4 illustrates an example of a content displayed the optimal joint position list display frame 60.

The diagram-α display frame 30 is a display area allocated to display the overall configuration, wiring routes, connection states of various sections, etc. of the wire harness (W/H) corresponding to the contents of the MT data 21 as a diagram α in a display form, such as a plan view.

The diagram-β display frame 40 is a display area allocated to display the detailed information on components, such as connectors, included in the wire harness corresponding to the contents of the MT data 21 as a diagram β in a display form such that the information is classified for each component and visually understandable.

The diagram-β display frame 40 shown in FIG. 2 includes component display areas 41, 42, 43, 44. Mutually different components are shown in the respective component display areas 41 to 44. Furthermore, the shape of a connector housing, the arrangement states of the respective cavities and terminals as viewed from the open face side of the housing, the connection state of each bus bar inside the connector, etc. are shown in each of the component display areas 41 to 44. Furthermore, in FIG. 2, for example, a selected joint point 41a is, for example, highlighted so as to be clearly distinguishable from the other points.

The diagram-γ display frame 50 is a display area allocated to display the specification table representing a list of various types of information included in the wire harness and corresponding to the contents of the MT data 21 as a diagram α. The information to be displayed in the diagram-γ display frame 50 can be displayed in a list form using character information and numerical value information while the information to be displayed is switched for each type of information by selecting the tabs 51 in the frame.

More specifically, the tabs 51 indicated by “Gamma”, “Cavity”, “Connector”, “Parts”, “Tape”, “Tube”, “Sheet”, “Dimension”, “Segment” and “Node” are provided as the types of information to be switched. “Gamma” represents information on each wire. “Cavity” represents information on the cavities and terminals of each connector. “Connector” represents information on each connector. “Parts” represents information on combined components. “Tape”, “Tube” and “Sheet” represent information on tape, tube and sheet serving as protective materials, respectively. “Dimension” represents information on dimensions. “Segment” represents information on the segments of a wire harness. “Node” represents information on, for example, the position of each node corresponding to a measuring point.

The optimal joint position list display frame 60 is a display area allocated to display necessary information at the time when a user or a designer considers changing the position of a joint point on a wire harness.

Diagram-α Display Frame 30

As shown in FIG. 3, a content 31 of the diagram α displayed in the diagram-α display frame 30 includes an overall configuration, wiring routes, connection states of various sections, etc. of a wire harness. The wire harness shown in FIG. 3 includes a joint point. In the example of FIG. 3, a joint connector is present at the position HA of the component indicated by label number “408” on the wire harness.

When the user or the designer selects this joint connector or its portion on the display screen, the circuits 32 of the selected joint group are, for example, highlighted so as to be clearly distinguishable from other portions. A joint group is defined as a group of components, such as wires, connected to a common circuit using a joint component, such as a bus bar. For example, in the case that three wires are connected to a common circuit using a joint, the three wires are included in the same joint group.

The position of a joint point on a wire harness can be changed. Furthermore, when the position of a joint point is changed, the lengths of the wires included in the corresponding joint group are changed, whereby the total wire length of the wire harness is also changed. Hence, the total weight and the cost of the wire harness can be reduced.

The post-change position P1B of the selected joint point can be automatically calculated and displayed as shown in FIG. 3 by using the joint position examining function 130 included in the assisting program 100. The total wire length of the wire harness can be made shortest by moving the selected joint point to the post-change position P1B. In other words, the joint position examining function 130 can automatically calculate the post-change position P1B that is optimal for making the total wire length of the wire harness shortest and can present this position to the user or the designer.

Optimal Joint Position List Display Frame 60

As shown in FIG. 4, the attributes of the plurality of wires included in the selected joint group are individually displayed in the optimal joint position list display frame 60. In the example shown in FIG. 4, the attributes of three electric wires are displayed at wire attribute display sections 61-1, 61-2, 61-3 on different lines.

The wire attribute display sections 61-1, 61-2, 61-3 are provided with areas displaying the following types of information: FROM-side information (one wire end-side terminal sign) 62-1, FROM-side information (one wire end-side connector number) 62-2, TO-side information (other wire end-side terminal sign) 62-3, TO-side information (other wire end-side connector number) 62-4, wire type information 62-5, wire diameter information 62-6, wire color information 62-7, post-change information 63, and pre-change information 64.

Each of the post-change information 63 and the pre-change information 64 includes information on wire length (Length), roughly estimated design cost (SPS) and weight (Weight). Further, areas displaying pre-change total wire length 65-1, post-change total wire length 65-2 and total wire length difference 65-3 are provided.

Examples of Joint Points

FIG. 5 illustrates an example of a connection of circuits in a joint connector. The joint connector 70 of FIG. 5 includes numerous terminals 71 and three bus bars 72, 73, 74 being independent of one another. In the case that wires 75-1 to 75-8 are connected to the respective terminals 70 of the joint connector 70 as shown in FIG. 5, circuits are connected as described below.

The wires 75-1, 75-2, 75-3 are electrically interconnected via the common bus bar 72 inside the joint connector 70. The wires 75-4, 75-5 are electrically interconnected via the common bus bar 73 inside the joint connector 70. The wires 75-6, 75-7, 75-8 are electrically interconnected via the common bus bar 74 inside the joint connector 70.

In the case of the joint points shown in FIG. 5, the position of the joint point on the wire harness can be changed in units of circuits connected via a common bus bar or in units of joint connectors. For example, in the case that a joint connector at another position has an empty terminal, circuits can be moved to the empty terminal in units of bus bars.

Furthermore, not only a joint connector but also a joint point being configured as a bonder, for example, can also be changed in a similar way.

Joint Position Examining Function 130

Process Flow

FIG. 6 illustrates an example of a flow of a process for examining a joint position. The joint position examining process is a process corresponding to a content of the joint position examining function 130 contained in the assisting program 100. In other words, when the computer 10 executes a program of the joint position examining function 130 with an instruction of a user, the process proceeds in accordance with the process flow shown in FIG. 6 and the operations by the user.

To the computer 10 executing the assisting program 100, the user can give instructions by operating various work menu items included in the operation menu 22 shown in FIG. 2 and by operating buttons, tabs, etc. in the respective display frames.

When the joint position examining process shown in FIG. 6 is started, the computer 10 reads the MT data 21 from the recording medium 20 at step S11, thereby grasping the current configuration of the corresponding wire harness according to this data.

At step S12, the computer 10 displays the routing configuration diagram (diagram α) of the wire harness (W/H), the component list (diagram β) and the specification table (diagram γ) on the display screen according to the MT data 21 having been read at step S11. In other words, the computer 10 displays the diagram-α display frame 30, the diagram-β display frame 40 and the diagram-γ display frame 50 shown in FIG. 2 and also displays the information representing the configuration of the wire harness in these respective frames.

In the case that the user carries out the joint position examination processing for this wire harness, the user operates, for example, the operation menu 22 and gives an instruction for the joint position examination processing to the computer 10. After the detection of this instruction, the processing on the computer 10 proceeds from step S13 to step S14. At this time, the computer 10 displays the optimal joint position list display frame 60 on the display screen.

The user further operates to select a single joint point to be examined. For example, the user selects any one of the joint connectors displayed in the diagram-β display frame 40 shown in FIG. 2 and also selects a single joint point included in the corresponding joint connector. More specifically, the user selects a single bus bar inside the joint connector and also selects a plurality of wire circuits interconnected via this bus bar by the input operation from the mouse. After the detection of this selection instruction, the processing on the computer 10 proceeds from step S14 to step S15.

At step S15, the computer 10 specifies all the circuits belonging to the group at the selected joint point. Furthermore, at step S16, the computer 10 highlights all the circuits at the joint point in the diagram-α display frame 30 and the diagram-β display frame 40.

Hence, the user can recognize the circuits at the joint point selected by him in a state of being clearly distinguished visually from the other circuits. For example, in the example shown in FIG. 2, only the joint point 41a selected in the diagram-β display frame 40 is highlighted. Besides, in the example shown in FIG. 3, only the circuits 32 belonging to the selected joint group are highlighted.

At this kind of joint point, for example, at a bus bar for interconnecting a plurality of wires, the position of the joint point on the wire harness can be moved to another position. However, the position of the movement destination is limited only to a node position corresponding to a measuring point on a design drawing because it is necessary to ensure dimensional accuracy.

In the processing from step S17 to step S21, the computer 10 calculates information required for making a judgement as to whether each of various node positions serving as the candidates of the movement destination of the joint point is appropriate and obtains the information.

At step S17, the computer 10 sequentially selects the node positions serving as the change destination candidates from among numerous node positions having been determined beforehand on the design drawing.

At step S18, the computer 10 discriminates whether each node position selected at step S17 corresponds to one of exception points having been determined beforehand. In the case that the node position is an exclusion point, the processing returns to step S17. In the case that the node position is not an exclusion point, the processing proceeds to step S19. For example, since a node position being located in a liquid intrusion area is inappropriate for a joint point (waterproofing treatment is necessary), the node position is registered beforehand in the computer 10 as an exclusion point.

At step S19, the computer 10 calculates the lengths of all the wires belonging to the group at the selected joint point in the case that the joint point is moved to the selected node position. Furthermore, at the next step S20, the computer 10 calculates the total length of all the wires belonging to the group at the selected joint point and stores the value of the total wire length in association with the node position.

The computer 10 repeats the processing from step S17 to step S21 at all the node positions serving as the change destination candidates. After this processing is completed, the processing on the computer proceeds from step S21 to step S22. At step S22, the computer 10 compares the total wire lengths calculated at step S20 among the candidate node positions with each other and specifies the candidate node position at which the total wire length becomes the shortest as the optimal node position. The computer 10 then displays the information on the optimal node position and the wire length on the display screen.

For example, in a case where the post-change position P1B shown in FIG. 3 is the optimal node position, the position P1B is displayed in the diagram-α display frame 30 as shown in FIG. 3 so that the position P1B on the wire harness is visually recognizable.

Further in a case where three wires are included in the group at the selected joint point, the pieces of information on the respective wires are displayed at the wire attribute display sections 61-1, 61-2, 61-3 in the optimal joint position list display frame 60 as shown in FIG. 4. The information on the total wire length calculated at the pre-change position P1A is displayed in the wire length (Length) column of the pre-change information 64, and the information on the total wire length calculated at the post-change position P1B is displayed in the wire length (Length) column of the post-change information 63. The difference between the total wire length in the pre-change information 64 and the total wire length in the post-change information 63 is displayed in the column of the total wire length difference 65-3.

In the example shown in FIG. 4, since the total wire length in the pre-change information 64 at the position P1A is “6266” and the total wire length in the post-change information 63 at the position P1B is “5372”, the information on the total wire length difference 65-3 indicates that the wire length is shortened by “894” by the change of the position. Hence, according to the information on the total wire length difference 65-3 displayed in the optimal joint position list display frame 60, the user can recognize that changing the position of the selected joint point from the position P1A to the position P1B is effective in shortening the wire length of the wire harness.

However, the optimal node position automatically selected at step S22 is not necessarily the truly optimal position. For example, the total weight may not be optimal or the cost may not be optimal. Hence, there is a possibility that the user may examine positions other than the optimal node position selected at step S22.

Hence, the computer 10 accepts the selective input of positions other than the optimal node position selected at step S22 from the user at step S23. After that, at step S24, the computer 10 displays the total wire length in the column of the post-change total wire length 65-2 based on the calculation result at the candidate node position selected at step S23 by the input operation of the user. Furthermore, the computer 10 updates the display content in the column of the total wire length difference 65-3.

Moreover, in the case that a still another candidate node position is selected by the input operation of the user, the processing on the computer 10 returns from step S25 to step S23, and the above-mentioned processing is repeated. Hence, the user can examine various candidate node positions other than the optimal node position as necessary while the wire length reducing effects in the case that the joint point is moved to the respective candidate node positions are displayed sequentially. Furthermore, in the case that an ending instruction is input by the user, the computer 10 ends the processing shown in FIG. 6.

Another Example of Process Flow

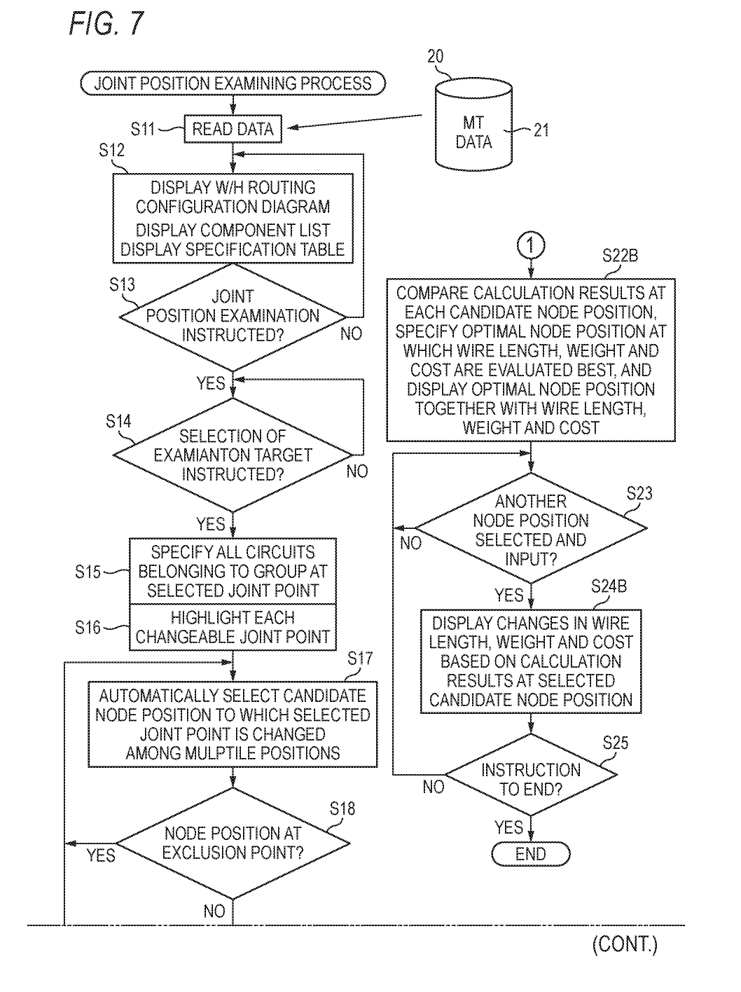

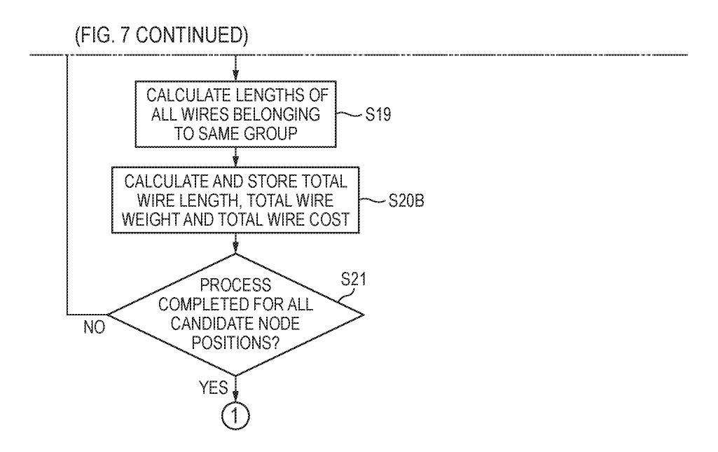

FIG. 7 illustrates another example of a flow of a process for examining the joint position. In the joint position examining process shown in FIG. 7, steps S20B, S22B, S24B are changed, but the other steps are the same as those in the joint position examining process of FIG. 6.

At step S20B in FIG. 7, the computer 10 calculates the total wire length, the total wire weight and the total wire cost of all the wires belonging to the group at the selected joint point and stores the values obtained as the results of the calculations in association with the node position.

Since the weight per unit length of a wire can be specified beforehand according to the type and thickness of the wire, the total wire weight can be calculated based on the specified constant and the wire length calculated at step S19. Similarly, since the roughly estimated design cost (SPS) per unit length of the wire can also be specified beforehand, the total wire cost can be calculated based on the specified constant and the wire length.

At step S22B, the computer 10 specifies the optimal node position based on the total wire length, the total wire weight and the total wire cost calculated at step S20B. For example, the position at which the total wire weight is the smallest may be determined as the optimal node position, or the position at which the total wire cost is the lowest may be determined as the optimal node position. The information on the optimal node position and the wire length is then displayed on the display screen.

At step S24B, the computer 10 displays the information on the total wire length, the total wire weight, the total wire cost and the differences among these values based on the calculation results at the candidate node position selected at step S23 by the input operation of the user.

MT Data

List of Attributes

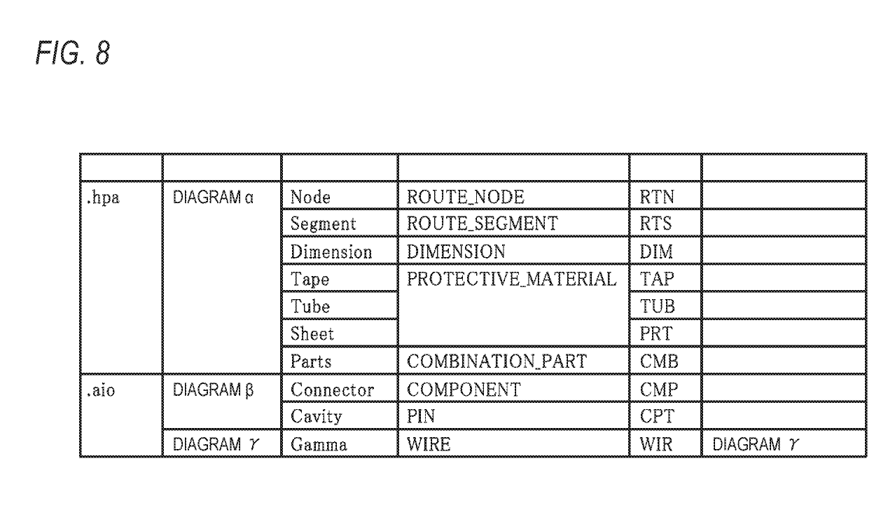

FIG. 8 illustrates a list of the attributes contained in the MT data 21. As shown in FIG. 8, the MT data 21 includes drawing data classified into three types: the diagram α, the diagram β and the diagram γ. Furthermore, the drawing data of the diagram α includes attribute elements classified into node (Node), segment (Segment), dimension (Dimension), tape (Tape), tube (Tube), sheet (Sheet) and parts (Parts).

Furthermore, the drawing data of the diagram β includes attribute elements: connector (Connector) and cavity (Cavity). The drawing data of the diagram γ includes data representing the attribute of wire (Wire). The details of information on typical attributes are described below.

Node Attribute Information

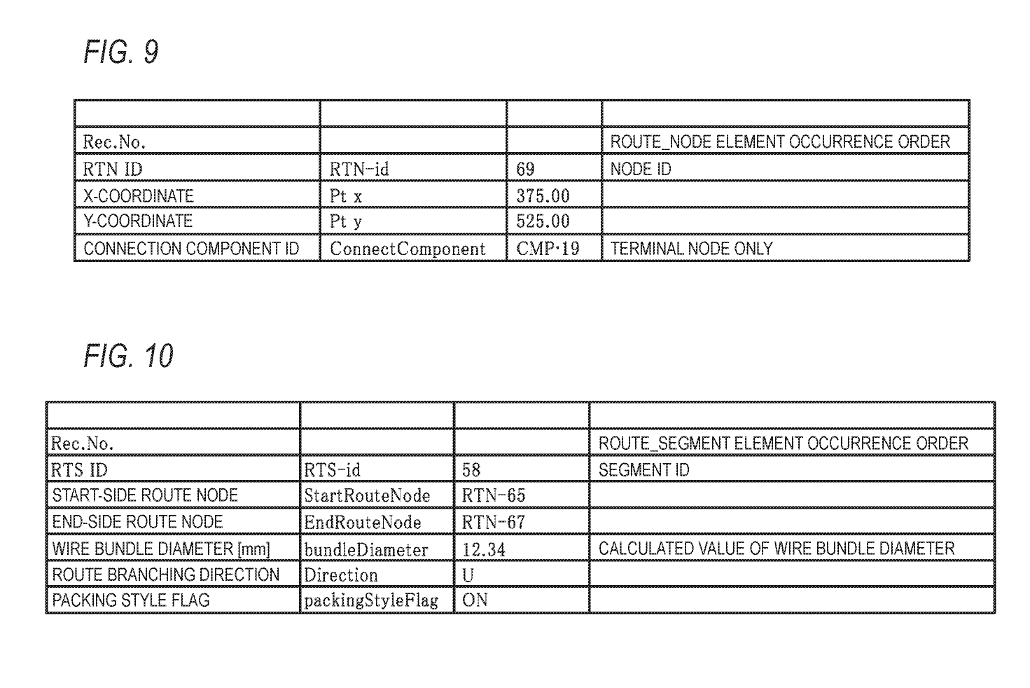

FIG. 9 illustrates an example of a configuration of node attribute information contained in the MT data 21. As shown in FIG. 9, the node attribute information includes address information (Rec. No.), node ID (RTN ID), X-coordinate, Y-coordinate and connection component ID.

Segment Attribute Information

FIG. 10 illustrates an example of a configuration of segment attribute information contained in the MT data 21. As shown in FIG. 10, the segment attribute information includes address information (Rec. No.), segment ID (RTS ID), start-side route node, end-side route node, bundle diameter, route branching direction and packing style flag.

Wire Attribute Information

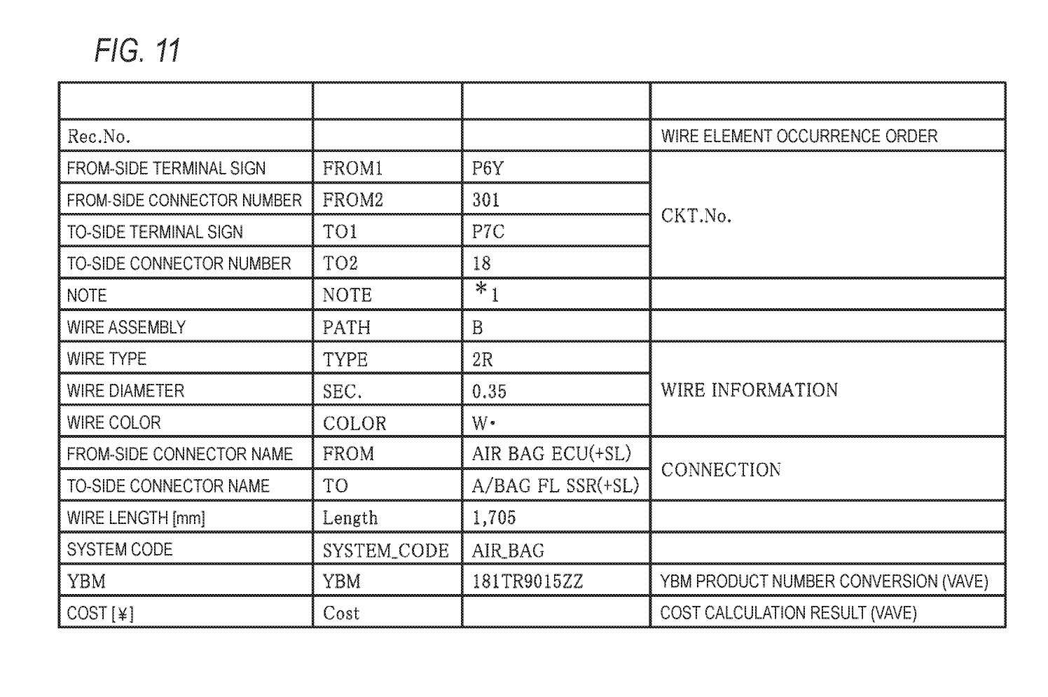

FIG. 11 illustrates an example of a configuration of wire attribute information (Gamma) contained in the MT data 21. As shown in FIG. 11, the wire attribute information includes wire number (Rec. No.), one end-side terminal sign (FROM1), one end-side connector number (FROM2), other end-side terminal sign (TO1), other end-side connector number (TO2), note (NOTE), wire assembly path (PATH), wire type (TYPE), wire diameter (SEC.), wire color (COLOR), one end-side connector name (FROM), other end-side connector name (TO), wire length (Length), system code, product number (YBM), and cost information (Cost).

### Advantageous Effect

When the computer 10 executes the joint position examining process shown for example in FIG. 6, the node position optimal as a destination candidate for moving the selected joint point can be displayed automatically as the post-change position P1B as shown in FIG. 3. Further, as in the display content of the optimal joint position list display frame 60 shown in FIG. 4, the pre-change information 64 and the post-change information 63 can be displayed so that the differences therebetween can be compared, and the total wire length difference 65-3 can be displayed. Consequently, the method can assist the work of the user and the designer and can reduce their burden.

According to one or more exemplary embodiments of the present invention, a joint position determination assisting method is provided. In a vehicle circuitry including an assembly of a plurality of wires and at least one joint point interconnecting the plurality of wires, the method assists an optimization of a position of the joint point. The method includes displaying visible information representing a wiring route and a configuration of the vehicle circuitry on a display screen based on basic design data (MT data 21) representing the configuration of the vehicle circuitry (Step S12), and in response to a designation of the joint point and an instruction for the optimization, calculating a length of each wire and a total wire length with the joint point being disposed at a plurality of mutually different positions (Steps S19, S20), and outputting information representing an optimal position of the joint point, reflecting a result of comparison of the calculated total wire length at the mutually different positions (Step S22).

With this method, the total wire lengths in cases where the joint point is disposed at the respective positions are calculated automatically, and the comparison results of these total wire lengths are reflected to the output. Hence, the designer can easily recognize how the position of each joint point can be changed to reduce the total wire length of, for example, a wire harness.

The outputting may include displaying a position of the joint point at which the calculated total wire length is the shortest among the plurality of mutually different positions as the optimal position of the joint point (Step S22).

With this method, among the plurality of positions selectable by a designer, the position at which the total wire length of the wire harness is the shortest can be displayed as the optimal position of the joint point.

The method may further include, in response to the designation of the joint point and the instruction for the optimization, calculating at least one of a total wire weight and a total wire cost with the joint point being disposed at the plurality of mutually different positions (Step 520B), and the outputting may include outputting the information representing the optimal position of the joint point, reflecting a result of comparison of at least one of the total wire length, the total wire weight and the total wire cost calculated at the respective mutually different positions (Step S22B).

With this method, the optimal position of the joint point is determined in consideration of not only the total wire length of the wire harness but also the total wire weight and the total wire cost. Hence, for example, even in a case where a plurality of wires having different thicknesses are connected at a joint point or a case where the cost varies for each type of wire or each joint point, the result optimized in view of the total weight and the total cost can be presented to the designer as the optimal position of the joint point.

The plurality of mutually different positions may be positions remaining after excluding predetermined exclusion points (Step S18) from all positions at which the joint point can be disposed.

With this method, the optimal position selected from numerous positions can be presented to the designer. Since one or more exclusion points are excluded from the targets for the processing, inappropriate positions can be avoided from being presented. For example, a position in a liquid intrusion area, such as an area inside an engine room, can be designated as the exclusion point, i.e., a position not suitable for the joint point.

The method may further include, in response to an input of a user designated position other than the optimal position after the outputting of the information representing the optimal position of the joint point in response to the designation of the joint point and the instruction for the optimization, recalculating the length of each wire and the total wire length with the joint point being disposed at the user designated position (Step S24).

With this method, the total wire length can be calculated and displayed also with the joint point being disposed at the user designated position. Hence, the designer can confirm whether there is a position more appropriate than the position presented as the optimal position.

What is claimed is:

1. A joint position determination assisting method, wherein in a vehicle circuitry including an assembly of a plurality of wires and at least one joint point interconnecting the plurality of wires, the method assists an optimization of a position of the joint point, the method comprising:
displaying visible information representing a wiring route and a configuration of the vehicle circuitry on a display screen based on basic design data representing the configuration of the vehicle circuitry; and
in response to a designation of the joint point and an instruction for the optimization,
calculating a length of each wire and a total wire length with the joint point being disposed at a plurality of mutually different positions; and
outputting information representing an optimal position of the joint point, reflecting a result of comparison of the total wire length calculated at the plurality of mutually different positions.

2. The method according to claim 1, wherein the outputting comprises displaying a position of the joint point at which the calculated total wire length is the shortest among the plurality of mutually different positions as the optimal position of the joint point.

3. The method according to claim 1, further comprising, in response to the designation of the joint point and the instruction for the optimization, calculating at least one of a total wire weight and a total wire cost with the joint point being disposed at the plurality of mutually different positions, and
wherein the outputting comprises outputting the information representing the optimal position of the joint point, reflecting a result of comparison of at least one of the total wire length, the total wire weight and the total wire cost calculated at the plurality of mutually different positions.

4. The method according to claim 1, wherein the plurality of mutually different positions are positions remaining after excluding at least one predetermined exclusion point from all positions at which the joint point can be disposed.

5. The method according to claim 1, further comprising, in response to an input of a user designated position other than the optimal position after the outputting of the information representing the optimal position of the joint point in response to the designation of the joint point and the instruction for the optimization, recalculating the length of each wire and the total wire length with the joint point being disposed at the user designated position.
